(19) United States
(12) Patent Application Publication
(10) Pub. No.: US 2013/0039626 A1
(43) Pub. Date: Feb. 14, 2013

(54) MULTIMODE OPTICAL FIBER AND OPTICAL BACKPLANE USING MULTIMODE OPTICAL FIBER

(71) Applicants: Scott Robertson Bickham, Corning, NY (US); George Edward Berkey, Pine City, NY (US); Andrey Evgenievich Korolev, St. Petersburg (RU); Ming-Jun Li, Horseheads, NY (US); Nataliya A. Lobanova, St. Petersburg (RU)

(72) Inventors: Scott Robertson Bickham, Corning, NY (US); George Edward Berkey, Pine City, NY (US); Andrey Evgenievich Korolev, St. Petersburg (RU); Ming-Jun Li, Horseheads, NY (US); Sergey A. Lobanov, St. Petersburg (RU)

(21) Appl. No.: 13/311,950

(22) Filed: Dec. 6, 2011

Related U.S. Application Data
(60) Provisional application No. 61/522,278, filed on Aug. 11, 2011.

(51) Int. Cl. G02B 6/028

(52) U.S. Cl. 385/124

(57) ABSTRACT

An optical backplane system is provided. The optical backplane system includes at least one transceiver, at least one optical connector, and a plurality of multimode optical fibers coupled to the at least one optical connector. Each multimode optical fiber includes a graded index glass core having a diameter in the range of 24 microns to 40 microns, a graded index having an alpha less than 2.12 and a maximum relative refractive index in the range between 0.6 percent and 1.9 percent. The optical backplane further includes a cladding surrounding and in contact with the core. The cladding includes a depressed-index annular portion. The fiber has an overfilled bandwidth greater than 2.0 GHz-km at 1310 nm.

### CROSS-REFERENCE TO RELATED APPLICATIONS

This application claims the benefit of priority under 35 U.S.C. §119 of U.S. Provisional Application Ser. No. 61/522,278, filed on Aug. 11, 2011, the content of which is relied upon and incorporated herein by reference in its entirety.

### BACKGROUND

The present invention generally relates to fiber optic communication, and more particularly relates to small diameter multimode optical fiber that may be particularly useful for use in an optical backplane.

High performance computing and server installations typically require a large number of processor-to-processor interconnections and utilize optical backplanes. Optical interconnects advantageously require much less electrical power than conventional wired systems and offer high speed data communication at long distances. Conventional fiber optic communication systems employ single mode or multimode optical fibers to transfer the data between remote locations. Multimode fiber optic cable offers a plurality of modes, but conventional multimode fibers generally require a relatively larger diameter core and thus generally result in larger overall diameter fibers.

### SUMMARY

According to one embodiment, a multimode optical fiber is provided. The fiber includes a graded index glass core having a diameter in the range of 24 microns to 40 microns, a graded index having an alpha profile less than 2.12 and a maximum relative refractive index in the range between 0.6 percent and 1.9 percent. The fiber also includes a cladding surrounding and in contact with the core. The cladding includes a depressed-index annular portion. The fiber further has an overfilled bandwidth greater than 2.0 GHz-km at 1310 nm.

According to another embodiment, an optical backplane system is provided. The optical backplane system includes at least one transceiver, at least one optical connector, and a plurality of multimode optical fibers coupled to the at least one optical connector. Each multimode optical fiber includes a graded index glass core having a diameter in the range of 24 microns to 40 microns, a graded index having an alpha parameter less than 2.12 and a maximum relative refractive index in the range between 0.6 percent and 1.9 percent. The optical backplane further includes a cladding surrounding and in contact with the core. The cladding includes a depressed-index annular portion. Each multimode optical fiber also has an overfilled bandwidth greater than 2.0 GHz-km at 1310 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a schematic diagram (not to scale) of the refractive index profile of a cross section of the glass portion of an exemplary embodiment of a multimode optical fiber having a depressed-index annular portion, according to one embodiment;

FIG. 2 is a cross-sectional view (not to scale) of the multimode optical fiber of FIG. 1;

FIG. 3 is a graph illustrating the refractive index profile of an exemplary embodiment of the multimode optical fiber;

FIG. 3A is a graph illustrating the refractive index profile of another exemplary embodiment of the multimode optical fiber;

FIG. 4 is a graph illustrating the refractive index profile of another embodiment of the multimode optical fiber; and

FIG. 5 is a schematic diagram illustrating a backplane system employing the multimode optical fiber, according to one embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

The “refractive index profile” is the relationship between refractive index or relative refractive index and waveguide fiber radius.

The “relative refractive index” is defined as Δ=100×[n(r)²−n_{cl}²)/2n(r)², where n(r) is the refractive index at the radial distance r from the fiber's centerline, unless otherwise specified, and n_{cl} is the refractive index of the cladding at a wavelength of 850 nm. In one aspect, the cladding comprises essentially pure silica. In other aspects, the cladding may comprise silica with one or more dopants (e.g., GeO₂, Al₂O₃, P₂O₅, TiO₂, ZrO₂, Nb₂O₅ and/or Ta₂O₅) which increase the index of refraction, in which case the cladding is “up-doped” with respect to pure silica. The cladding may also comprise silica with one or more dopants (e.g., F and/or B) which decrease the index of refraction, in which case the cladding “down-doped” with respect to pure silica. As used herein, the relative refractive index is represented by delta or Δ and its values are typically given in units of “%,” unless otherwise specified. In cases where the refractive index of a region is less than that of the cladding, the relative index percent is negative and is referred to as having a depressed index, and is calculated at the point at which the relative index is most negative unless otherwise specified. In cases where the refractive index of a region is greater than the refractive index of silica, the relative index percent is positive and the region can be said to be raised or to have a positive index, and is calculated at the point at which the relative index is most positive, unless otherwise specified.

An “up-dopant” is herein considered to be a dopant which has a propensity to raise the refractive index relative to pure undoped SiO₂. A “down-dopant” is herein considered to be a dopant which has a propensity to lower the refractive index relative to pure undoped SiO₂. An up-dopant may be present in a region of an optical fiber having a negative relative refractive index when accompanied by one or more other dopants which are not up-dopants. Likewise, one or more other dopants which are not up-dopants may be present in a region of an optical fiber having a positive relative refractive index. A down-dopant may be present in a region of an optical fiber having a positive relative refractive index when accompanied by one or more other dopants which are not down-dopants. Likewise, one or more other dopants which are not down-dopants may be present in a region of an optical fiber having a negative relative refractive index.

As used herein, numerical aperture of the fiber means numerical aperture as measured using the method set forth in TIA SP3-2839-URV2 FOTP-177 IEC-60793-1-43 titled “Measurement Methods and Text Procedures-Numerical Aperture.”

The term graded index, “α-profile” or “alpha profile,” as used herein, refers to a relative refractive index profile, expressed in terms of Δ which is in units of “%”, where r is the radius and which follows the equation,

$$Δ ( r ) = {Δ}_{0} [ 1 - {( \frac{r}{{R}_{1}} )}^{α} ] ,$$

where Δ₀ is the relative refractive index extrapolated to r=0, R₁ is the radius of the core (i.e. the radius at which Δ(r) is zero), and α is an exponent which is a real number. For a step index profile, the alpha value is greater than or equal to 10. For a graded index profile, the alpha value is less than 10. The term “parabolic,” as used herein, includes substantially parabolically shaped refractive index profiles which may vary slightly from an α value of 2.0 at one or more points in the core, as well as profiles with minor variations and/or a centerline dip. The modeled refractive index profiles that exemplify the invention have graded index cores which are perfect alpha profiles. An actual fiber will typically have minor deviations from a perfect alpha profile, including features such as dips or spikes at the centerline and/or a diffusion tail at the outer interface of the core. However accurate values of alpha and Δ₀ may still be obtained by numerically fitting the measured relative refractive index profile to an alpha profile over the radius range from 0.05 R₁≦r≦0.95 R₁. In ideal graded index fibers with no imperfections such as dips or spikes at the centerline, Δ_{O}=Δ_{1MAX}, where Δ_{1MAX} is the maximum refractive index of the core. In other cases, the value from Δ₀ obtained from the numerical fit from 0.05 R₁≦r≦0.95 R₁ may be greater or less than Δ_{1MAX}.

Various embodiments of a multimode optical fiber exhibiting a small diameter with enhanced performance characteristics are provided. Multimode optical fiber is disclosed having a graded index glass core and a cladding surrounding and in contact with the core. The core has a small diameter in the range of 24 microns to 40 microns or a radius in the range of 12 microns to 20 microns. The core also includes a graded index having an alpha (α) value less than 2.12, preferably less than 2.04 and more preferably between 1.95 and 2.04. The core further has a maximum refractive index in the range between 0.6 percent and 1.9 percent. The cladding includes a depressed-index annular portion. The fiber further has an overfilled bandwidth greater than 2.0 GHz-km at 1310 nm.

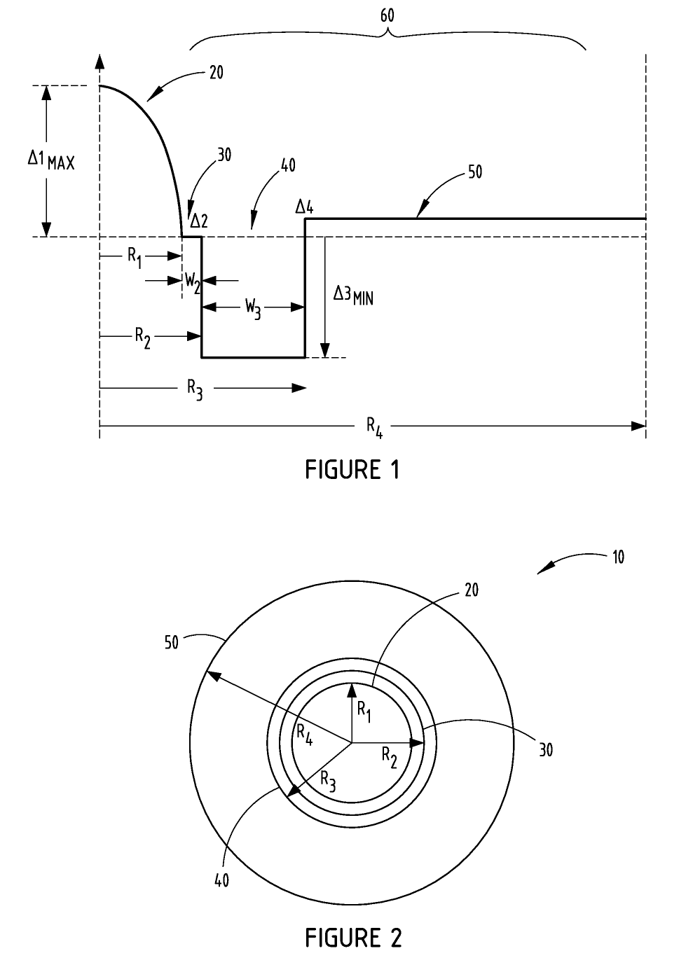

Referring to FIG. 1, a schematic representation of the refractive index profile of the cross section of the glass portion of a multimode optical fiber 10 is shown, according one embodiment. The multimode optical fiber 10 includes a glass core 20 and a glass cladding 60 that surrounds the core 20 and is in contact with the core 20. The core 20 may include silica doped with germanium, according to one embodiment. According to other embodiments, dopants other than germanium, such as Al₂O₃ or P₂O₅ singly or in combination, may be employed within the core 20, and particularly at or near the centerline of the optical fiber 10. The cladding 60 includes an inner annular portion 30, a depressed-index annular portion 40, and an outer annular portion 50. The inner annular portion 30 surrounds and is in contact with the core 20. The depressed-index annular portion 40 surrounds and is in contact with the inner annular portion 30. The outer annular portion 50 surrounds and is in contact with the depressed-index annular portion 40. The cladding 60 may further include additional portions (not shown) such as further glass portions surrounding the outer annular portion 50. The fiber 10 may further include a protective coating surrounding the cladding 60.

Referring to both FIGS. 1 and 2, the multimode optical fiber 10 is shown with the core 20 having an outer radius R₁. According to one embodiment, the core outer radius R₁ is in the range of 12 to 20 microns, which corresponds to a core diameter in the range of 24 microns to 40 microns. Thus, the multimode optical fiber 10 employs a small diameter core 20, which results in an overall small diameter fiber 10. The glass core 20 has a graded index having an alpha (α) value less than 2.12, according to one embodiment. According to another embodiment, the core graded index has an alpha value less than 2.05. The glass core 20 further has a maximum relative refractive index Δ_{1MAX} in the range of 0.6 percent to 1.9 percent, according to one embodiment. According to a further embodiment, the core 20 has a maximum relative refractive index Δ_{1MAX} greater than 0.8 percent.

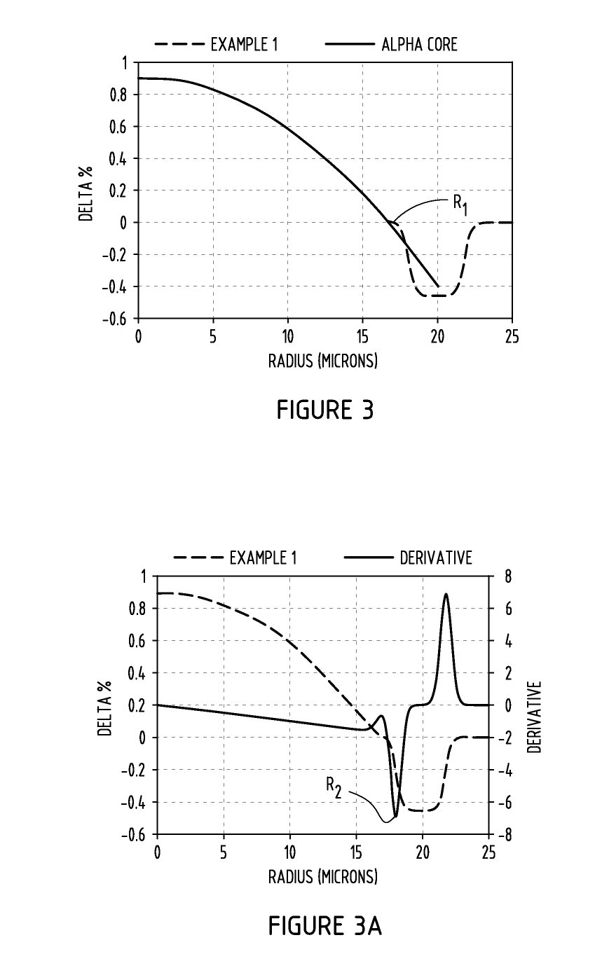

The inner cladding portion 30 of cladding 60 has an outer radius R₂, a width W₂, relative refractive index Δ₂, and a maximum relative refractive index Δ_{2MAX}. R₂ is defined as the radius at which the derivative of the normalized refractive index profile with respect to the normalized radius, d(Δ/Δ_{1MAX})/d(r/R₁), has a local minimum, as shown in FIG. 3A. The width W₂ of the inner cladding portion 30 may be in the range of 0.5 to 4.0 microns, according to one embodiment. The outer radius R₂ of the inner cladding portion 30 is generally in the range between 12 and 22 microns. In some embodiments, the maximum relative refractive index Δ_{2MAX} of the inner cladding is less than about 0.1%. In other embodiments, the maximum relative refractive index Δ_{2MAX} of the inner cladding is less than about 0.0%. In other embodiments, the maximum relative refractive index Δ_{2MAX} of the inner cladding is between about −0.2% and about 0.0%.

The depressed-index annular portion 40 of cladding 60 has a minimum relative refractive index Δ_{3MIN} and extends from R₂ to R₃, wherein R₃ is the radius at which Δ₃(r) first reaches a value of greater than −0.05%, going radially outwardly from the radius at which Δ₃(r)=Δ_{3MIN}. The depressed-index annular portion 40 has a radial width W₃=R₃−R₂. In one embodiment, the depressed-index annular portion 40 has a width W₃ of at least 1 micron. W₃ is preferably between 2 μm and 10 μm, more preferably between 2 μm and 8 μm and even more preferably between 2 μm and 6 μm. The depressed-index annular portion 40 may have an outer radius R₃ in the range of 13 to 23 microns. The depressed-index annular portion 40 has a minimum relative refractive index Δ_{3MIN} of less than about −0.2 percent, and more preferably refractive index Δ_{3MIN} may be in the range of −0.2 to −0.54. The low index ring has a minimum relative refractive Δ_{3MIN} which is less than or equal to Δ_{2MAX} and less than Δ_{1MAX}.

The outer annular portion 50 of cladding 60 has an outer radius R₄ and has relative refractive index Δ₄ which is greater than Δ_{2MAX} and greater than Δ_{3MIN} and less than Δ_{MAX}. Accordingly, Δ_{1MAX}>Δ₄>Δ_{2MAX}>Δ_{3MIN} in this embodiment. However, it should be understood that other embodiments are possible. For example, Δ₄ may be equal to Δ_{2MAX}. Alternatively, Δ_{2MAX} may be greater than Δ₄. According to one embodiment, the outer radius R₄ is less than 60 microns, thereby resulting in a diameter of less than 120 microns. According to another embodiment, the outer radius R₄ of outer annular portion 50 has an outer radius of less than 50 microns, or a diameter of less than 100 microns. It should be appreciated that by using a small diameter core 20 in the range of 24-40 microns, an overall reduced diameter of the fiber 10 as indicated by the outer radius R₄ is likewise reduced thereby providing a smaller cross section which allows for efficient coupling to devices, such as an array planar waveguide.

Fiber 10 preferably has an overfilled bandwidth greater than 2.0 GHz-km at 1310 nm, and a numerical aperture greater than about 0.185. The cutoff wavelengths of modes in the eleventh (11^{th}) mode group are less than 1310 nm, and more preferably the fiber guides fewer than ten mode groups at a wavelength of 1310 nm or greater.

The refractive index profile of a radially symmetric optical fiber depends on the radial coordinate r and is independent of the azimuthal coordinate φ. In most optical fibers, including the examples disclosed below, the refractive index profile exhibits only a small index contrast, and the fiber can be assumed to be only weakly guiding. If both of these conditions are satisfied, Maxwell's equations can be reduced to the scalar wave equation, the solutions of which are linearly polarized (LP) modes.

For a given wavelength, the radial equation of the scalar wave equation for a given refractive index profile has solutions which tend to zero for r going to infinity only for certain discrete values of the propagation constant β. These Eigen vectors (transverse electric field) of the scalar wave equation are guided modes of the fiber, and the Eigen values are the propagation constants βₗₘ, where l is the azimuthal index and m is the radial index. In a graded index fiber, the LP modes can be divided into groups, designated by common values of the principle mode number, p=1+2m−1. The modes in these groups have nearly degenerate propagation constants and cutoff wavelengths and tend to propagate through the fiber with the same group velocity.

The cutoff wavelength of a particular mode group is the minimum wavelength beyond which all modes from that mode group cease to propagate in the optical fiber. The cutoff wavelength of a single mode fiber is the minimum wavelength at which an optical fiber will support only one propagating mode. The cutoff wavelength of a single mode fiber corresponds to the highest cutoff wavelength among the higher order modes. Typically the highest cutoff wavelength corresponds to the cutoff wavelength of the LP11 mode. If the operative wavelength is below the cutoff wavelength, multimode operation may take place and the introduction of additional sources of dispersion may limit a fiber's information carrying capacity. A mathematical definition can be found in Single Mode Fiber Optics, Jeunhomme, pp. 39 44, Marcel Dekker, New York, 1990 wherein the theoretical fiber cutoff is described as the wavelength at which the mode propagation constant becomes equal to the plane wave propagation constant in the outer cladding. This theoretical wavelength is appropriate for an infinitely long, perfectly straight fiber that has no diameter variations.

For example, the LP modes in a fiber that propagates 7 mode groups are: LP01, LP11, (LP02 and LP21), (LP12 and LP31), (LP03, LP22 and LP41), (LP13, LP32 and LP51) and (LP04, LP23, LP42, LP61). The requirements for a fiber propagating fewer than 7 mode groups is that the cutoff wavelengths of all of the modes in the 7^{th} mode group are less than the operating wavelength λ. The mode with the lowest/value generally has the highest cutoff wavelength in a graded index multimode fiber. If the operating wavelength is 1310 nm, it is sufficient to require that the LP04 cutoff wavelength is less than 1310 nm. Similarly, the requirements for a fiber propagating fewer than 8, 9, 10 or 11 mode groups at 1310 nm are that the LP14, LP05, LP15 and LP06 cutoff wavelengths, respectively, are less than 1310 nm.

The numerical aperture (NA) is defined as the sine of the maximum angle (relative to the axis of the fiber) of the incident light that becomes completely confined in the fiber by total internal reflection. It can be shown that this condition yields the relationship NA=\sqrt{n₁²−n₂²}. Using the definition of delta (A), this expression can be transformed into the following equation:

$$NA = {n}_{1} \sqrt{2 Δ} = {n}_{2} \sqrt{\frac{2 Δ}{1 - 2 Δ}}$$

The overfilled bandwidth at a given wavelength is measured according to measurement standard FOTP-204 using an overfilled launch. The modeled bandwidth may be calculated according to the procedure outlined in T. A. Lenahan, “Calculation of Modes in an Optical Fiber Using the Finite Element Method and EISPACK,” Bell Sys. Tech. J., vol. 62, pp. 2663-2695 (1983), the entire disclosure of which is hereby incorporated herein by reference. Equation 47 of this reference is used to calculate the modal delays; however note that the term dk_{clad}/dω² must be replaced with dk_{clad}²/dω², where k_{clad}=2π*n_{clad}/λ and ω=2π/λ. The modal delays are typically normalized per unit length and given in units of ns/km. The calculated bandwidths also assume that the refractive index profile is ideal, with no perturbations such as a centerline dip, and as a result, represent the maximum bandwidth for a given design.

### EXAMPLES

The tables 1-5 presented below summarize various examples generally arranged in five sets of embodiments of multimode fibers that were modeled having various characteristics in accordance with the embodiments disclosed herein and compared to a comparative fiber shown in FIG. 1. Various calculations of the parameters of the multi-mode fibers were calculated. These parameters include the relative refractive index of the core relative refractive index Δ_{iMAX} of the core, outer core radius R₁, and the graded index alpha (α) parameter. Additionally, the parameters include the inner cladding relative refractive index Δ₂, the inner cladding maximum relative refractive index Δ_{2MAX}, the outer radius of the inner annular portion of the cladding R₂, and the width W₂ of the inner annular portion 40. Further, the parameters include the minimum relative refractive index Δ_{3MIN} of the depressed-index annular portion 50, and the outer radius R₃ of the depressed-index annular portion 50. Further calculations include the bandwidth at 1310 MHz-km, the number of mode groups at 1310 nm, the bandwidth at 1550 MHz-km, the number of mode groups at 1550 nm, the geometrical core diameter in microns, the optical core diameter in microns, and the numerical aperture.

In the examples presented below, the multimode fiber generally exhibit a core diameter between 24 and 40 microns and a core maximum relative refractive index Δ_{1MAX} between 0.6 and 1.9%, wherein the core diameter and core delta provide for (in terms of narrowness): LP06 cutoff wavelength less than 1310 nm (fewer than 11 mode groups); LP15 cutoff wavelength less than 1310 nm (fewer than 10 mode groups—preferred); LP05 cutoff wavelength less than 1310 nm (fewer than 9 mode groups—more preferred); and LP14 cutoff wavelength less than 1310 nm (fewer than 8 mode groups—most preferred).

The first set of embodiments identified as Fibers 1-3 in Table 1 below has approximately the same core maximum relative refractive index Δ_{1MAX} as the comparative fiber example, which is a commercially available multimode fiber sold by Corning Inc. under the name ClearCurve® MMF. The comparative fiber has a large core radius of about 23.7 microns and generally exhibits a large number of mode groups, shown as 11 mode groups at 1310 nm. In example fibers 1-3, only 7 mode groups propagate at 1310 nm due to the smaller core diameter, and this enables bandwidths as large as 14 GHz-km at either 1310 or 1550 nm. The numerical apertures of these first three embodiments are between 0.185 and 0.215.

TABLE 1

| Example | Fiber 1 | Fiber 2 | Fiber 3 | Comparative Fiber |
|---|---|---|---|---|
| Delta1MAX (%) (Δ_{1MAX}) | 0.902 | 0.902 | 0.902 | 0.898 |
| R1 (microns) | 16.69 | 16.69 | 16.42 | 23.91 |
| Alpha (α) | 2.022 | 1.997 | 2.022 | 2.115 |
| R2 (microns) | 18.07 | 18.07 | 17.70 | 25.34 |
| W2 (microns) | 1.38 | 1.37 | 1.28 | 1.43 |
| Delta3MIN (%) (Δ_{3MIN}) | −0.45 | −0.45 | −0.4 | −0.46 |
| R3 (microns) | 21.8 | 21.8 | 21.8 | 31.2 |
| W3 (microns) | 3.74 | 3.74 | 4.11 | 5.87 |
| BW1310 (MHz-km) | 12418 | 2467 | 14494 | 547 |
| Mode Groups at 1310 nm | 7 | 7 | 7 | 11 |
| BW1550 (MHz-km) | 2525 | 15377 | 2611 | 457 |
| Mode Groups at 1550 nm | 6 | 6 | 6 | 9 |
| Geometrical Core Diameter (microns) | 33.4 | 33.4 | 32.8 | 47.8 |
| Optical Core Diameter (microns) | 36.1 | 36.1 | 35.4 | 50.7 |
| Numerical Aperture | 0.198 | 0.198 | 0.198 | 0.197 |

The second set of embodiments identified as example fibers 4-8 in Table 2 below support the propagation of 10 mode groups at 1310 nm. The maximum achievable bandwidth is significantly lower than the value that is possible with fewer than 10 mode groups. The numerical apertures of embodiments 4-8 are greater than 0.22 and the overfilled bandwidths at 1310 nm are greater than 3700 MHz-km. Embodiments 6-8 illustrate than an overfilled bandwidth greater than 5500 MHz-km at 1310 nm is possible when the core maximum relative refractive index Δ_{1MAX}), is less than 1.7% and the numerical aperture is less than 0.27.

TABLE 2

| Example | Fiber 4 | Fiber 5 | Fiber 6 | Fiber 7 | Fiber 8 |
|---|---|---|---|---|---|
| Delta1MAX (%) (Δ_{1MAX}) | 1.841 | 1.740 | 1.568 | 1.373 | 1.149 |
| R1 (microns) | 14.90 | 15.23 | 16.13 | 17.30 | 19.05 |
| Alpha | 2.026 | 2.028 | 2.021 | 2.027 | 2.018 |
| R2 (microns) | 15.42 | 15.875 | 16.925 | 18.305 | 20.27 |
| W2 (microns) | 0.52 | 0.65 | 0.80 | 1.00 | 1.22 |
| Delta3MIN (%) (Δ_{3MIN}) | −0.4 | −0.42 | −0.45 | −0.45 | −0.45 |
| R3 (microns) | 20.5 | 20 | 21 | 23 | 25 |
| W3 (microns) | 5.08 | 4.13 | 4.08 | 4.70 | 4.73 |
| BW1310 (MHz-km) | 3796 | 4204 | 5884 | 6819 | 7416 |
| Mode Groups at 1310 nm | 10 | 10 | 10 | 10 | 10 |
| BW1550 (MHz-km) | 1277 | 1235 | 1434 | 1410 | 1708 |
| Mode Groups at 1550 nm | 8 | 8 | 8 | 8 | 8 |
| Geometrical Core Diameter (microns) | 29.8 | 30.5 | 32.3 | 34.6 | 38.1 |
| Optical Core Diameter (microns) | 30.8 | 31.8 | 33.9 | 36.6 | 40.5 |
| Numerical Aperture | 0.288 | 0.279 | 0.264 | 0.246 | 0.224 |

The third set of embodiments identified as example fibers 11-15 in Table 3 below supports 7 mode groups at 1310 nm, as do the examples in the first set above, but have different combinations of the core relative refractive index Δ₁ and radius R₁. Embodiments 11-15 have numerical apertures greater than 0.185 and overfilled bandwidths at 1310 nm greater than 5000 MHz-km. Embodiments 14 and 15 illustrate that bandwidths as large as 14 GHz-km are possible when the core maximum relative refractive index Δ_{1MAX} is less than 1.0% and the numerical aperture is between 0.185 and 0.215.

TABLE 3

| Example | Fiber 11 | Fiber 12 | Fiber 13 | Fiber 14 | Fiber 15 |
|---|---|---|---|---|---|
| Delta1MAX (%) (Δ_{1MAX}) | 1.414 | 1.254 | 1.079 | 0.952 | 0.841 |
| R1 (microns) | 12.14 | 13.69 | 15.14 | 16.25 | 17.10 |
| Alpha | 2.019 | 2.021 | 2.025 | 2.019 | 2.019 |
| R2 (microns) | 12.80 | 14.50 | 16.20 | 17.31 | 18.59 |
| W2 (microns) | 0.65 | 0.81 | 1.06 | 1.06 | 1.49 |
| Delta3MIN (%) (Δ_{3MIN}) | −0.45 | −0.42 | −0.42 | −0.35 | −0.5 |
| R3 (microns) | 17 | 19 | 21 | 22.2 | 22.2 |
| W3 (microns) | 4.21 | 4.50 | 4.80 | 4.89 | 3.62 |
| BW1310 (MHz-km) | 6300 | 11468 | 13390 | 15738 | 20844 |
| Mode Groups at 1310 nm | 7 | 7 | 7 | 7 | 7 |
| BW1550 (MHz-km) | 1226 | 1939 | 2237 | 2608 | 2021 |
| Mode Groups at 1550 nm | 6 | 6 | 6 | 6 | 6 |
| Geometrical Core Diameter (microns) | 24.3 | 27.4 | 30.3 | 32.5 | 34.2 |
| Optical Core Diameter (microns) | 25.6 | 29.0 | 32.4 | 34.6 | 37.2 |
| Numerical Aperture | 0.25 | 0.235 | 0.217 | 0.203 | 0.191 |

The fourth set of embodiments identified as example fibers 16-18 in Table 4 below has fiber designs which support 9 mode groups at 1310 nm while example fibers 19-21 support 6 mode groups at 1310 nm. In comparison with the second set of embodiments, which support 10 mode groups at 1310 nm, the designs with 9 mode groups offer a slight improvement, but still do not enable 10 GHz-km. Examples 16-18 have numerical apertures greater than 0.22 and overfilled bandwidths at 1310 nm greater than 5000 MHz-km. The designs designated as examples 19-21 propagate 6 mode groups and enable higher bandwidth than embodiments that support 7 mode groups, but the smaller core radius may result in higher sensitivity to misalignments. Examples 19-21 have numerical apertures between 0.185 and 0.22 and overfilled bandwidths at 1310 nm greater than 15000 MHz-km.

TABLE 4

| | Example | | | | | |
|---|---|---|---|---|---|---|
| | Fiber 16 | Fiber 17 | Fiber 18 | Fiber 19 | Fiber 20 | Fiber 21 |
| Delta1MAX (%) (Δ_{1MAX}) | 1.644 | 1.371 | 1.180 | 1.083 | 0.906 | 0.809 |
| R1 (microns) | 13.99 | 15.51 | 16.97 | 12.58 | 14.19 | 15.07 |
| Alpha | 2.031 | 2.028 | 2.025 | 2.014 | 2.020 | 2.025 |
| R2 (microns) | 14.72 | 16.43 | 18.14 | 13.50 | 15.35 | 16.42 |
| W2 (microns) | 0.73 | 0.92 | 1.17 | 0.92 | 1.16 | 1.35 |
| Delta3MIN (%) (Δ_{3MIN}) | −0.45 | −0.45 | −0.45 | −0.45 | −0.45 | −0.45 |
| R3 (microns) | 18.5 | 21 | 22.5 | 17 | 20 | 20 |
| W3 (microns) | 3.79 | 4.58 | 4.36 | 3.51 | 4.65 | 3.59 |
| BW1310 (MHz-km) | 5315 | 8141 | 8730 | 16126 | 18003 | 22249 |
| Mode Groups at 1310 nm | 9 | 9 | 9 | 6 | 6 | 6 |
| BW1550 (MHz-km) | 1353 | 1560 | 1999 | 2277 | 2196 | 2422 |
| Mode Groups at 1550 nm | 7 | 7 | 7 | 6 | 6 | 6 |
| Geometrical Core | 28.0 | 31.0 | 33.9 | 25.2 | 28.4 | 30.1 |
| Diameter (microns) | | | | | | |
| Optical Core Diameter | 29.4 | 32.9 | 36.3 | 27.0 | 30.7 | 32.8 |
| (microns) | | | | | | |
| Numerical Aperture | 0.271 | 0.246 | 0.227 | 0.217 | 0.198 | 0.187 |

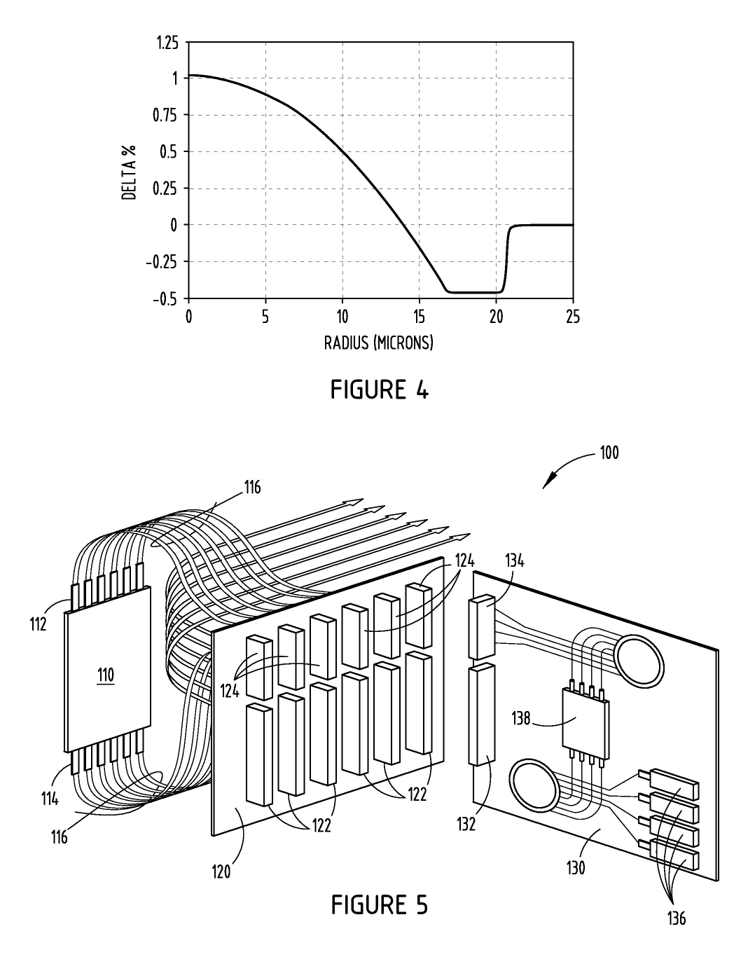

The fifth set of embodiments identified as example fibers 22-26 in table 5 below has fiber designs in which the inner cladding region is an extension of the graded index core, as shown in FIG. 4. These examples support 6 or 7 mode groups at 1310 nm, have numerical apertures greater than 0.185 and overfilled bandwidths at 1310 nm greater than 15000 MHz-km.

TABLE 5

| Example | 22 | 23 | 24 | 25 | 26 |
|---|---|---|---|---|---|
| Delta1MAX (%) (Δ_{1MAX}) | 0.809 | 0.898 | 0.798 | 0.900 | 1.010 |
| R1 (microns) | 16.07 | 15.40 | 15.63 | 14.79 | 13.92 |
| Alpha | 2.031 | 2.029 | 2.026 | 2.031 | 2.036 |
| R2 (microns) | 19.71 | 18.48 | 19.16 | 17.76 | 16.32 |
| W2 (microns) | 3.64 | 3.08 | 3.53 | 2.97 | 2.39 |
| Delta3MIN (%) (Δ_{3MIN}) | −0.45 | −0.45 | −0.45 | −0.45 | −0.45 |
| R3 (microns) | 23.99 | 22.80 | 23.47 | 22.06 | 20.69 |
| W3 (microns) | 4.28 | 4.32 | 4.32 | 4.30 | 4.37 |
| BW1310 (MHz-km) | 23207 | 17490 | 33119 | 27002 | 20255 |
| Mode Groups at 1310 nm | 7 | 7 | 6 | 6 | 6 |
| BW1550 (MHz-km) | 2773 | 2497 | 3282 | 2885 | 2542 |
| Mode Groups at 1550 nm | 6 | 6 | 5 | 5 | 5 |
| Geometrical Core Diameter (microns) | 32.1 | 30.8 | 31.3 | 29.6 | 27.8 |
| Optical Core Diameter (microns) | 39.4 | 37.0 | 38.3 | 35.5 | 32.6 |
| Numerical Aperture | 0.187 | 0.197 | 0.186 | 0.198 | 0.210 |

Table 6 presented below provides a further example, labeled example 27, of parameters measured for a multimode fiber made having characteristics similar to those shown in example 1 of the multimode fiber. Further parameters of the multimode fiber 27 are expected to have similar properties to those in the modeled version of example 1.

TABLE 6

| Example | 27 |
|---|---|
| Delta1MAX (%) (Δ_{1MAX}) | 0.93 |
| R1 (microns) | 15.21 |
| Alpha | 2.115 |
| R2 (microns) | 15.92 |
| W2 (microns) | 0.71 |
| Delta3MIN (%) (Δ_{3MIN}) | −0.52 |
| R3 (microns) | 20.54 |
| W3 (microns) | 4.62 |

The fiber examples in Tables 1-6 illustrate that a reduced diameter graded index core in the range of 24 microns to 40 microns employed in a multimode optical fiber with a core maximum relative refractive index Δ_{1MAX} in the range of 0.6 to 1.9 percent with a cladding surrounding the core and comprising a depressed-index annular portion, and the fiber having an overfilled bandwidth greater than 2.0 GHz-km at 1310 nm.

FIG. 3 illustrates a refractive index profile with the inner annular portion 30 of a fiber having an index profile as described above with respect to FIG. 1. The example illustrated in FIG. 3 is a multimode fiber configured according to fiber 1 in the embodiment provided in Table 1 and comprises a graded index core and a cladding surrounding the core, wherein the cladding comprises an inner annular portion, a depressed annular portion surrounding the inner annular portion, and an outer annular portion surrounding the depressed annular portion. The core has an outer radius R₁ of 16.69 microns and the inner annular portion comprises a width of 1.38 microns. The glass core and the inner cladding have alpha values that are different. FIG. 3A illustrates a refractive index profile and a derivative of the normalized refractive index profile.

FIG. 4 illustrates a refractive index profile of the inner annular portion 30 region of a fiber having an index profile as described above with respect to FIG. 1 and configured according to fiber 26 in the embodiment provided in Table 5. In FIG. 4, the graded index core is extended by matching the alpha value of the glass core with the alpha value of the inner cladding so as to provide a smooth decreasing delta value.

Referring to FIG. 5, an optical backplane system 100 is illustrated employing the multimode optical fibers described herein, according to one embodiment. The optical backplane system 100 includes an optical backplane 110 optically coupled to an electrical/mechanical backplane 120 which, in turn, is optically coupled to a system card 130. The system card 130 may be a daughter board, according to one embodiment. The optical backplane 110 is optically connected to the electrical/mechanical backplane 120 and system card 130 via a plurality of ribbon cables 116. Each of the ribbon cables 116 include the plurality of multimode optical fiber as described herein. The ribbon cables 116 may connect to a plurality of racks/shelves as part of the optical backplane system 100. The optical backplane 110 include an optical cross connect having connecting terminals 112 and 114 connecting to the ribbon cables 116.

The electrical/mechanical backplane 120 includes electrical circuitry 122 which engages electrical connectors 132 on each of the system cards 130. Additionally, the electrical/mechanical backplane 120 includes a plurality of optical connectors 124 which matingly engage optical connectors 134 on each of the system cards 130. The optical connectors 134 and 124 may perform an optical connection at an angle, such as 90°. This may be achieved by using a mirror to direct the optical signals at 90° or by bending a fiber optic cable at an angle of 90°. It should be appreciated that each of the optical connectors 124 may engage an optical connector 134 from a corresponding system card 130.

The system card 130 is shown further employing a plurality of transceivers 136 for receiving and sending optical signals. Transceiver 136 include both a transmit fiber and a receive fiber, according to one embodiment. Transceiver 136 may further be associated with electrical circuitry that converts the optical signal to electrical signals. Transceivers 136 are coupled to optical cross connect devices 138 which direct the optical signals from the optical connector 134 to the appropriate receiver 136. It should be appreciated that the optical backplane system 100 may be configured in any of a number of arrangements to provide optical signals between optical circuits, each employing a multimode fiber as described herein.

Accordingly, the multimode optical fiber and optical backplane system 100 utilizing the multimode optical fiber advantageously provides for a reduced footprint and good performance optical communication. The multimode optical fiber employs a reduced diameter core resulting in overall reduced diameter fiber thereby reducing the footprint of the fiber. The multimode fiber advantageously provides optimum core maximum relative refractive index values and alpha profiles. The cladding provides a depressed-index angular portion with an optimal overfill bandwidth value to achieve enhanced performance in a small diameter multimode fiber.

It will be apparent to those skilled in the art that various modifications and variations can be made without departing from the spirit or scope of the claims.

What is claimed is:

1. A multimode optical fiber comprising:
a graded index glass core having a diameter in the range of 24 microns to 40 microns, a graded index having an alpha profile less than 2.12 and a maximum relative refractive index in the range between 0.6 percent and 1.9 percent; and
a cladding surrounding and in contact with the core, said cladding comprising a depressed-index annular portion, wherein the fiber has an overfilled bandwidth greater than 2.0 GHz-km at 1310 nm.

2. The optical fiber of claim 1, wherein the cladding comprises an inner annular portion surrounding and in contact with the core, the depressed-index annular portion surrounding the inner annular portion, and an outer annular portions surrounding and in contact with the depressed-index annular portion.

3. The optical fiber of claim 1, wherein the depressed-index annular portion has a refractive index less than about negative 0.2 percent.

4. The optical fiber of claim 1, wherein the depressed-index annular portion has a width of at least 1 micron.

5. The optical fiber of claim 1, wherein the core has a maximum refractive index greater than 0.8 percent.

6. The optical fiber of claim 1, wherein the numerical aperture is greater than about 0.185.

7. The optical fiber of claim 1, wherein cutoff wavelengths of the modes in the eleventh mode group are less than 1310 nm.

8. The optical fiber of claim 1, wherein the fiber has an overfilled bandwidth greater than 5.0 GHz-km at 1310 nm.

9. The optical fiber of claim 1, wherein the fiber guides fewer than ten mode groups at 1310 nm.

10. The optical fiber of claim 1, wherein the core has an alpha profile less than 2.04.

11. The optical fiber of claim 1, wherein the outer diameter of the cladding is less than 120 microns.

12. The optical fiber of claim 1, wherein the outer diameter of the cladding is less than 100 microns.

13. The optical fiber of claim 1, wherein the fiber is coupled to an optical backplane comprising a planar optical waveguide.

14. The optical fiber of claim 1, wherein a plurality of said fibers are coupled to an array of planar optical waveguides.

15. The optical fiber of claim 1, wherein the fiber is coupled to a VCSEL, wherein said VCSEL is modulated at a rate greater than 10 GHz.

16. The optical fiber of claim 1, wherein the fiber has an overfilled bandwidth greater than 4.0 GHz-km at 1310 nm.

17. An optical backplane system comprising:
at least one transceiver;
at least one optical connector;
a plurality of multimode optical fibers coupled to the at least one optical connector, each multimode optical fiber comprising:
a graded index glass core having a diameter in the range of 24 microns to 40 microns, a graded index having an alpha profile less than 2.12 and a maximum relative refractive index in the range between 0.6 percent and 1.9 percent; and
a cladding surrounding and in contact with the core, said cladding comprising a depressed-index annular portion, wherein the fiber has an overfilled bandwidth greater than 2.0 GHz-km at 1310 nm.

18. The backplane system of claim 17, wherein each fiber is directed 90° relative to the backplane.

19. The backplane system of claim 17, wherein the cladding comprises an inner annular portion surrounding and in contact with the core, the depressed-index annular portion surrounding the inner annular portion, and an outer annular portions surrounding and in contact with the depressed-index annular portion.

20. The backplane system of claim 17, wherein each fiber guides fewer than two mode groups at 1310 nm or greater.
